(19) United States
(12) Patent Application Publication
(10) Pub. No.: US 2013/0222951 A1
(43) Pub. Date: Aug. 29, 2013

(54) FAULT PROTECTION CIRCUIT FOR PHOTOVOLTAIC POWER SYSTEM

(71) Applicants: Huibin Zhu, Westford, MA (US); David Smith, Daleville, VA (US); Anthony William Galbraith, Wirtz, VA (US); David Scott Wilmer, Troutville, VA (US)

(72) Inventors: Huibin Zhu, Westford, MA (US); David Smith, Daleville, VA (US); Anthony William Galbraith, Wirtz, VA (US); David Scott Wilmer, Troutville, VA (US)

(73) Assignee: GENERAL ELECTRIC COMPANY, Schenectady, NY (US)

(21) Appl. No.: 13/406,944

(22) Filed: Feb. 28, 2012

(51) Int. Cl. H02H 9/00

(52) U.S. Cl. 361/18

(57) ABSTRACT

A fault protection scheme for a photovoltaic power converter system is provided. According to aspects of the present disclosure, a fault protection circuit is coupled between a power converter and a ground reference. The fault protection circuit includes a fuse and a current sensor coupled in series with the fuse. A controller is configured to receive current readings from the current sensor and compare the current readings to a current threshold. The current threshold is selected to be less than the fuse current rating of the fuse. The controller identifies a fault condition if the current flowing through the ground protection circuit exceeds the current threshold value. A contactor can also be provided to temporarily lift the power converter relative to the ground reference to determine the existence of other fault paths in the system.

### FIELD OF THE INVENTION

The present disclosure relates generally to solar power generation and, more particularly, to a ground fault protection scheme for a photovoltaic power converter system.

### BACKGROUND OF THE INVENTION

Solar power generation is becoming an increasingly larger source of alternative energy production throughout the world. Solar power generation systems typically include one or more photovoltaic array (PV arrays) having multiple interconnected solar cells that convert solar energy into DC power through the photovoltaic effect. To interface the output of the PV arrays to a utility grid, a power converter system is needed to convert the DC power output of the PV array into a 60/50 HZ AC current waveform suitable for application to the utility grid.

It is desirable to include protection schemes to protect various electrical components of the power converter system from ground fault conditions and other conditions where electrical current leaks outside its intended flow path. A typical ground fault protection scheme can include the use of a fuse located between a the power converter and ground. This ground fault protection scheme can be effective against true ground fault events, especially in small-to-medium scale power converter systems.

In larger power converter systems, the fuse current ratings are typically required to be much higher (e.g. in the range of about 3 A to about 5 A) as a result of factors such as IGBT leakage current, cable wiring to ground capacitance, motor bearing current, load to ground leakage current, and other factors. These larger fuse ratings create a non-detectable zone for certain ground faults that do not yield much ground current, such as a ground current below the fuse rating. For instance, the larger fuse ratings may not be able to address ground faults having a fault point voltage that is low relative to ground, such as a short circuit fault between a PV array negative terminal and ground.

These ground faults can often appear to be minor as the ground fuse remains good. However, because these ground faults do not generate sufficient current to trip the fuse, the system controller for the power converter system may not be able to detect the presence of the ground fault condition. This can lead to major safety issues, such as a fire risk, if additional faults begin occurring in the system.

Attempts have been made to improve ground-fault protection schemes by sensing common-mode current at the power converter input from the PV array. However, the cost of current sensors used to sense the common-mode current can be prohibitive in larger power converter systems. In addition, current sensing accuracy can play a significant role when attempting to detect a few amps of common-mode current from hundreds or thousands of amps of differential current.

Another approach is to send an RF signal through the power converter system and monitor the impedance of various components of the power converter system to identify the presence of fault conditions. This approach, however, can be relatively expensive and can only be effective for floating or ungrounded power converter systems.

Thus, a need exists for improved detection of ground fault conditions in large scale photovoltaic power converter systems. A system and method that can be implemented in a cost effective and efficient manner would be particularly useful.

### BRIEF DESCRIPTION OF THE INVENTION

Aspects and advantages of the invention will be set forth in part in the following description, or may be obvious from the description, or may be learned through practice of the invention.

One exemplary aspect of the present disclosure is directed to a power converter system. The system includes a power converter couplable to one or more DC power sources, such as photovoltaic sources. The power converter is configured to convert DC power from the one or more DC power sources to AC power. The system further includes a fault protection circuit coupled between the power converter and a ground reference. The fault protection circuit includes a fuse having a fuse current rating and a current sensor in series with the fuse. The current sensor is configured to monitor the current flowing through the fault detection circuit. The system further includes a controller configured to receive a signal associated with the current flowing through the fault protection circuit from the current sensor. The controller is configured to compare the current flowing through the fault protection circuit with a current threshold and to identify a fault condition when the current exceeds the current threshold value. The current threshold value is less than the fuse current rating of the fuse.

Another exemplary aspect of the present disclosure is directed to a ground fault protection method for a power converter system. The method includes monitoring the current flowing through a fault protection circuit coupled between the power converter system and a ground reference. The fault protection circuit includes a fuse having a fuse current rating. The method further includes monitoring the voltage across the fuse; and identifying a minor fault condition based at least in part on the current flowing through the fault protection circuit and the voltage across the fuse. The current flowing through the fault protection circuit as a result of the minor fault condition has a magnitude less than the fuse current rating of the fuse.

Yet another exemplary aspect of the present disclosure is directed to a photovoltaic power converter system. The system includes a power converter couplable to one or more photovoltaic sources and configured to convert DC power from the one or more photovoltaic sources to AC power. The system further includes a fault protection circuit coupled between the power converter and a ground reference. The fault protection circuit includes a fuse having a fuse current rating and a contactor in series with the fuse. The system further includes a controller configured to open and close the contactor. The controller is configured to determine a closed contactor voltage for one or more components of the photovoltaic power converter system when the contactor is closed; determine an open contactor voltage for one or more components of the photovoltaic power converter system when the contactor is open; and, determine a fault condition based at least in part on a difference between the closed contactor voltage and the open contactor voltage for the one or more components of the photovoltaic power converter system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a circuit diagram of an exemplary photovoltaic power converter system according to an exemplary embodiment of the present disclosure;

FIG. 2 depicts a flow diagram of an exemplary method according to an exemplary embodiment of the present disclosure;

FIG. 3 depicts a circuit diagram of an exemplary photovoltaic power converter system according to an exemplary embodiment of the present disclosure; and,

FIG. 4 depicts a flow diagram of an exemplary method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a fault protection scheme for a power converter system. According to aspects of the present disclosure, a fault protection circuit is coupled between a power converter and a ground reference. The fault protection circuit includes a fuse having a fuse current rating that is generally selected such that the fuse will clear upon the occurrence of a major fault condition. The fault protection circuit also includes a current sensor coupled in series with the fuse. A controller is configured to receive current readings from the current sensor and compare the current readings to a current threshold. The current threshold is selected to be less than the fuse current rating of the fuse. The controller is configured to identify a fault condition if the current flowing through the ground protection circuit exceeds the current threshold value. In a particular implementation, the controller is configured to identify either a major fault condition or a minor fault condition based on the current flowing through the ground fault protection circuit and the voltage across the fuse.

In this manner, the fault protection scheme according to aspects of the present disclosure provides a simple and cost effective tool for identifying fault conditions in the non-detectable zone for the power converter system (e.g. ground fault conditions that are less than the current rating of the fault protection fuse). Moreover, the addition of a current sensor and continuous monitoring of fault protection circuit leakage current allows for a higher current rating for the ground fault protection fuse and avoids unnecessary ground fault tripping.

According to another aspect of the present disclosure, the fault protection circuit can further include a contactor coupled in series with the fuse. The contactor can be used to temporarily decouple (or couple in the case of floating power converter systems) the power converter from the ground reference. The voltage of various components of the power converter system, such as inputs from the DC source, a DC link positive and negative bus, or other suitable components, can be monitored and compared to voltages during conditions when the power converter is coupled to the ground reference (or decoupled from the ground reference in the case of floating power converter systems). This allows for the detection of other grounding paths in the power converter system other than the path provided by the fault protection circuit.

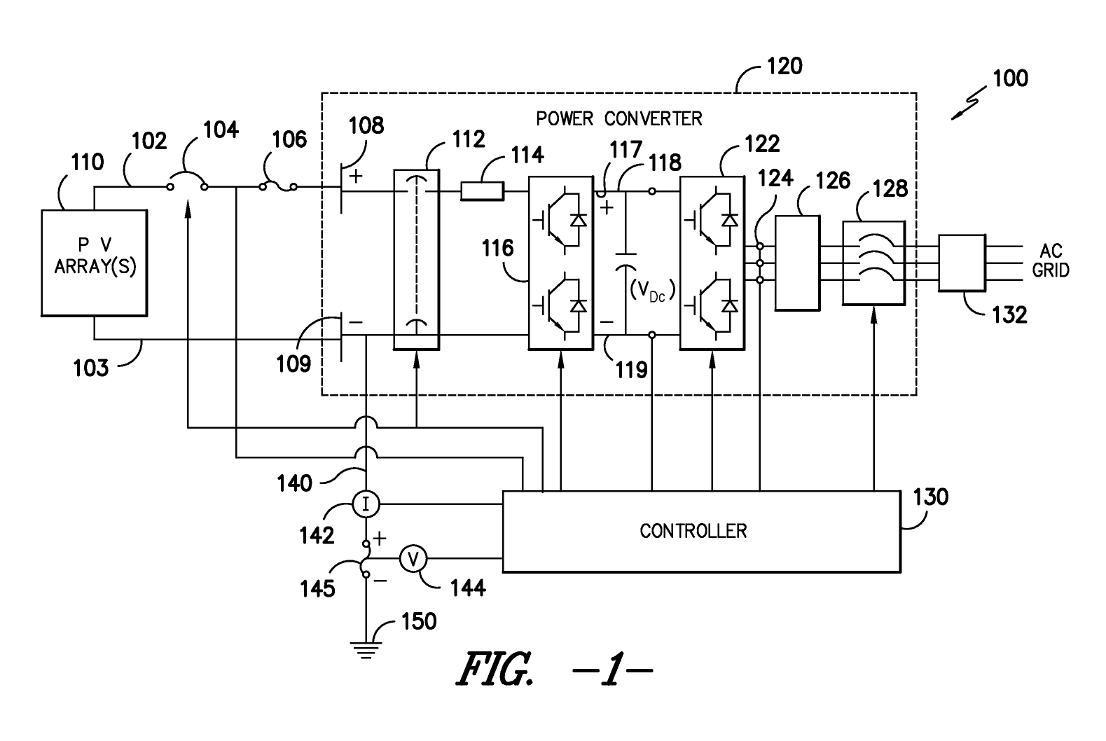

FIG. 1 depicts a circuit diagram of an exemplary power converter system 100 according to an exemplary embodiment of the present disclosure. The power converter system 100 includes a power converter 120 used to convert DC power generated by one or more PV array(s) 110 into AC power suitable for feeding to an AC power system. The power converter 120 depicted in FIG. 1 is a two-stage power converter 120 that includes a boost converter 116 and an inverter 122. While the present subject matter is discussed with reference to a two-stage power converter 120, those of ordinary skill in the art, using the disclosures provided herein, should understand that any suitable power converter can be used without deviating from the scope of the present disclosure.

The boost converter 120 boosts the DC voltage supplied by the PV array(s) 110 and provides the DC voltage to the DC link 118. The DC link 118 couples the boost converter 116 to the inverter 122. The inverter 122 converts the DC power provided through the DC link 118 into AC power. Boost converter 116 can be a part of or integral with inverter 122 or can be a separate stand alone structure. In addition, more than one boost converter 116 can be coupled to the same inverter 122 through one or more DC links.

Power converter system 100 includes a controller 130 that is configured to control various components of the power converter system 100, including both the boost converter 116 and the inverter 122. For instance, the controller 130 can send commands to the boost converter 116 to regulate the output of the boost converter 116 pursuant to a control method that regulates the duty cycle of switching devices (e.g. IGBTs or other power electronic devices) used in the boost converter 116. Controller 130 can also regulate the output of inverter 122 by varying modulating commands provided to the inverter 122. The modulation commands control the pulse width modulation provided by switching devices (e.g. IGBTS or other power electronic devices) to provide a desired real and/or reactive output by the inverter 122. As will be discussed in more detail below, controller 130 can also be used to control various other components, such as circuit breakers, disconnect switches, and other devices to control the operation of the power converter system 100. The controller 130 can include any number of suitable control device such a processor, a microcontroller, a microcomputer, a programmable logic controller, an application specific integrated circuit or other control device.

The components of the exemplary power converter system 100 will now be discussed in more detail. PV array(s) 110 include a plurality of interconnected solar cells that produce DC power in response to solar energy incident on the PV array(s). The PV arrays 110 are coupled the power converter 120 through a positive input line 102 and a negative input line 103. The positive input line 102 is coupled to a positive terminal 108 associated with the power converter 120. The negative input line 103 is coupled to a negative terminal 109 associated with the power converter 120.

The positive input line 102 can include a disconnect switch 104 or circuit breaker that is used for coupling and decoupling the PV array(s) 110 from the power converter 120. The controller 130 can be configured to control the opening and closing of the switch 104 to couple and decouple the PV array(s) 110 from the power converter 120.

The positive input line 102 can further include a surge protection fuse 106. The surge protection fuse 106 can have a fuse rating set such that the fuse 106 will clear upon the occurrence of a short circuit condition or other fault condition in the power converter system 100. Similarly, the switch 104 can be a circuit breaker configured to trip upon the occurrence of a short circuit condition or other fault condition in the power converter system 100. The power converter 120 can also include a circuit breaker 112 that can be configured to trip upon the occurrence of a short circuit condition or other fault condition in the power converter system 100. The controller 130 can be configured to control the operation of the circuit breaker 112 to power up and power down the power converter 120 as necessary.

The power converter 120 can provide DC power from the PV array(s) 110 to the boost converter 116 through various appropriate filtering devices 114. As discussed above, the boost converter 116 receives the DC power from the PV array(s) 110 and provides DC power to the DC link 118. In particular, boost converter 116 boosts the DC voltage from the PV array(s) 110 to a higher voltage and controls the flow of DC power onto the DC link 118. While a boost converter 116 is depicted in FIG. 1, those of ordinary skill in the art, using the disclosures provided herein, should understand that any DC to DC converter can be used as the first stage of power converter 120, such as a boost converter, buck converter, or buck/boost converter.

Boost converter 116 has a plurality of switching devices that can include one or more power electronic devices such as IGBTs. The switching devices of the boost converter 116 control the flow of DC power onto the DC link 118. In particular embodiments, controller 130 controls the DC power provided onto the DC link 118 by sending gate timing commands to the IGBT switching devices used in the boost converter 116.

The DC link 118 couples the boost converter 116 to inverter 122. DC link 118 can include one or more capacitors to provide stability and can include a positive bus 117 and a negative bus 119. The controller 130 can regulate the DC link by controlling the boost converter 116 and/or the inverter 122. For instance, the controller 130 can regulate the output of the inverter 122 to provide a desired DC link voltage.

Inverter 122 converts the DC power on the DC link 118 into AC power that is suitable for being fed to an AC power grid. The inverter 122 has an output 124 that provides AC power to the AC power grid through appropriate filters 126, a disconnect switch 128 and a transformer 132. FIG. 1 illustrates a three-phase output for inverter 122. However, those of ordinary skill in the art, using the disclosures provided herein, should understand that a single-phase or other multi-phase AC output could be provided without deviating from the scope of the present disclosure.

Inverter 122 uses one or more inverter bridge circuits that include power electronic devices, such as IGBTs and diodes, that are used to convert DC power into a suitable AC waveform. In certain embodiments, inverter 122 uses pulse-width modulation (PWM) to synthesize an output AC voltage at the AC grid frequency. The output of the inverter 122 can be controlled by controller 130 by providing gate timing commands to the IGBTs of the inverter bridge circuits according to well-known PWM techniques. The output AC power from the inverter 122 can have components at the PWM chopping frequency and the grid frequency.

The controller 130 can be configured to monitor various aspects of the power converter system 100. For instance, as illustrated, the controller 130 can monitor the voltage and/or current of the input 102 from the PV array(s) 110, the voltage and/or current on the positive bus 117 and negative bus 119 of the DC link, and the voltage and/or current of the output 124 of the inverter 122. Various current sensors and voltage sensors can be used to monitor the voltage and current of the components of the power converter system 100. For instance, current shunts and/or Hall effect sensors can be used to monitor various currents throughout the power converter system 100. The controller 130 can control various aspects of the power converter system 120, such as switch 104, circuit breaker 112, boost converter 116, inverter 122, switch 128, and other components based on the measured parameters.

According to a particular aspect of the present disclosure, the system 100 includes a fault protection circuit 140 coupled between the negative terminal of the power converter 120 and a ground reference 150. The fault protection circuit 140 is used to protect the power converter 120 from ground fault conditions and other fault conditions. During certain ground fault conditions, current will flow through ground fault protection circuit 140 to the ground reference 150.

As is known, fault protection circuit 140 includes a fuse 145 having a fuse rating selected such that the fuse is configured to clear upon the occurrence of major fault conditions. For instance, for larger power converter systems, the fuse 145 can have a fuse rating in the range of about 3 A to about 5 A. The use of a fuse 145 with a relatively large fuse rating can lead to presence of a non-detectable zone for smaller faults having a magnitude of less than the fuse rating of the fuse 145.

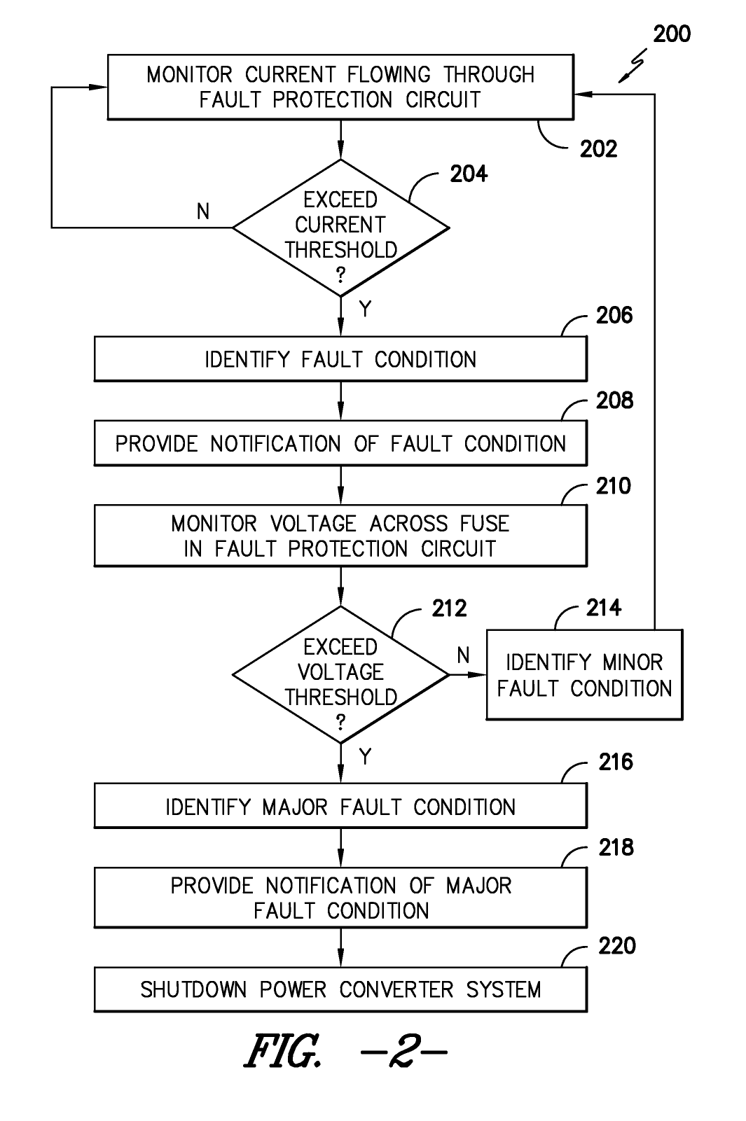

To address the occurrence of faults in the non-detectable zone, the fault protection circuit 140 includes a current sensor 142 coupled in series with the fuse 145. The current sensor 142 can include a current shunt, a Hall effect sensor, or other suitable sensor configured to monitor the current flowing through the fault protection circuit 140. The current sensor 142 provides a signal to controller 130 associated with the magnitude of the current flowing through the fault protection circuit 140. As will be discussed with reference to FIG. 2 below, the controller 130 determines the existence of fault conditions in the non-detectable zone based on the current flowing through the fault protection circuit 140. The controller 130 can provide a notification or alert of the fault conditions so that appropriate corrective action can be taken.

The fault protection circuit 140 can further include a voltage sensor 144 configured to monitor the voltage across the fuse 145. When a fault condition occurs that is sufficient to clear the fuse 145, the voltage across the cleared fuse will rise. The controller 130 can monitor the voltage across the fuse 145 to determine the existence of major fault conditions and control the power converter system 100 to address the fault condition, such as by shutting down the power converter 120.

FIG. 2 depicts an exemplary fault protection method 200 according to an exemplary embodiment of the present disclosure. The method 200 will be discussed with reference to the power converter system 100 depicted in FIG. 1. Those of ordinary skill in the art, using the disclosures provided herein, will understand that the method 200 can be implemented by other power converter systems. In addition, although FIG. 2 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (202), the method includes monitoring current flowing through a fault protection circuit. For instance, controller 130 can monitor the current flowing through fault protection circuit 140 through use of current sensor 142. The current sensor can provide a signal to the controller 130 associated with the current flowing through the fault protection circuit 140.

At (204), the method determines whether the current flowing through the fault protection circuit exceeds a current threshold. The current threshold is set to be less than the fuse current rating of a fuse used in the fault protection circuit. For instance, the current threshold is set to be less than the fuse current rating of fuse 145 used in fault protection circuit 140. The controller 130 can determine whether the current flowing through the fault protection circuit 140 is greater than the current threshold. If the current does not exceed the current threshold, the method identifies a fault condition for the power converter system (206). Otherwise, the current flowing through the fault protection circuit continues to be monitored (202).

After identification of a fault condition (206), a notification can be provided of the fault condition to a system administrator or other user (208). The notification can be an alert or other notification of the fault condition so that appropriate diagnostics and corrective action can be taken.

To determine whether a relatively minor fault condition has occurred or whether major fault condition has occurred that requires shutting down of the power converter system 110 to prevent damage, the method can further include monitoring the voltage across the fuse in the fault protection circuit (210). For instance, the controller 130 can monitor the voltage across fuse 145 using voltage sensor 144.

At (212) the method determines whether the voltage across the fuse exceeds a voltage threshold. As discussed above, if a major fault condition occurs sufficient to clear the fuse, the voltage across the fuse will rise. If the voltage has risen above a threshold value, the method identifies the occurrence of a major fault condition (216). Otherwise the method identifies the fault condition as a minor fault condition (214) and can continue to monitor the current flowing through the fault protection circuit as discussed above (202).

A minor fault condition typically does not require shut down of the power converter system. A notification of a minor fault condition can alert the user of the existence of a fault condition that needs to be addressed. However, the user can understand that the power converter system 100 does not have to be shut down immediately to address the fault condition. Of course, the user or controller 130 can always shut down the power converter system 100 immediately to address the minor fault condition if desired

If a major fault condition has occurred, the method notifies a user of the major fault condition (218) and takes appropriate action to shut down the power converter system to prevent damage to the system (220). For instance, the controller 130 can control one or more of the switch 104, circuit breaker 112, boost converter 116, inverter 122, and switch 128 to power down the power converter system 100. In this manner, damage resulting from fault conditions can be avoided.

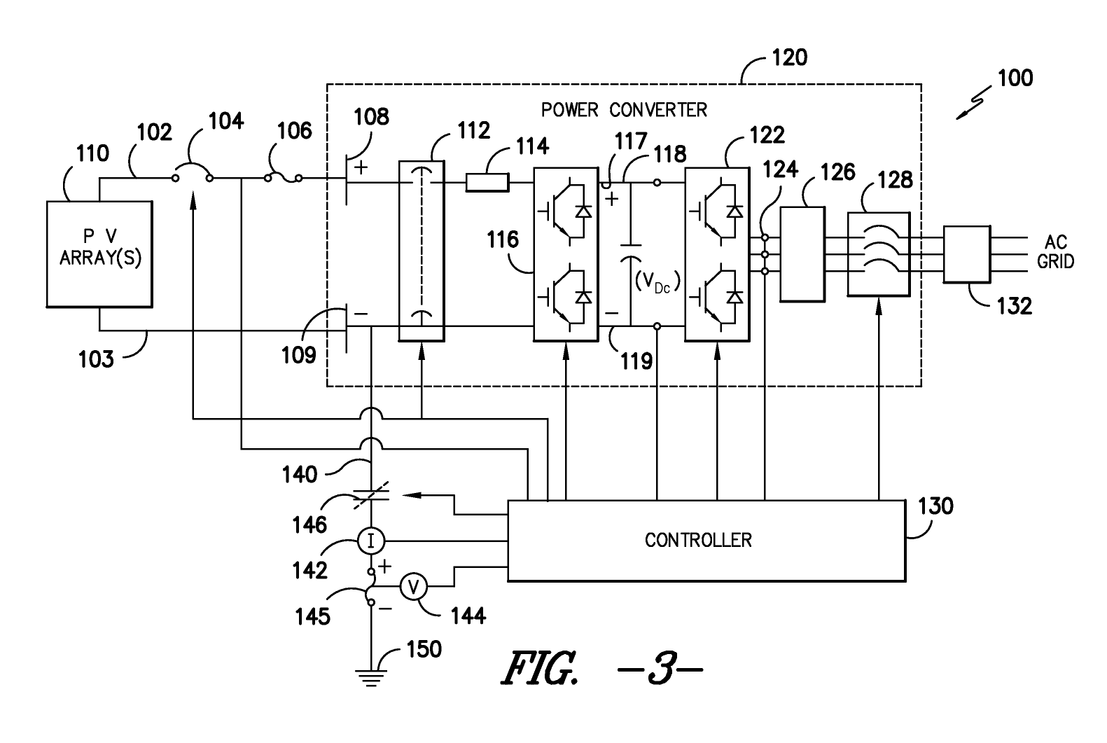

FIG. 3 depicts a circuit diagram of a power converter system 100 according to another exemplary embodiment of the present disclosure. The power converter system 100 is substantially similar to the power converter system 100 of FIG. 1, except that the fault protection circuit 140 further includes a contactor 146 coupled in series with the fuse 145.

The contactor 146 can be controlled by controller 130 to selectively couple and decouple the power converter 120 from the ground reference 150. The contactor 146 can be controlled to lift up the grounding path for the power converter 120 provided by the fault protection circuit 140 to detect if other grounding paths might exist for the power converter system 100. In particular, the voltages of various components of the power converter system 100 can be measured with the contactor 146 open and with the contactor 146 closed to identify fault conditions for the system 100. For instance, the voltage at the PV array input 102, the DC link positive bus 117, and/or the DC link negative bus 119 can be monitored while the contactor 146 is opened and closed to determine the existence of other fault paths in the power converter system 100. This also allows detection of the failure of one or more surge-protection devices for the power converter system 100, such as failure of the switch 104, fuse 106, circuit breaker 112, switch 128 or other surge protection device.

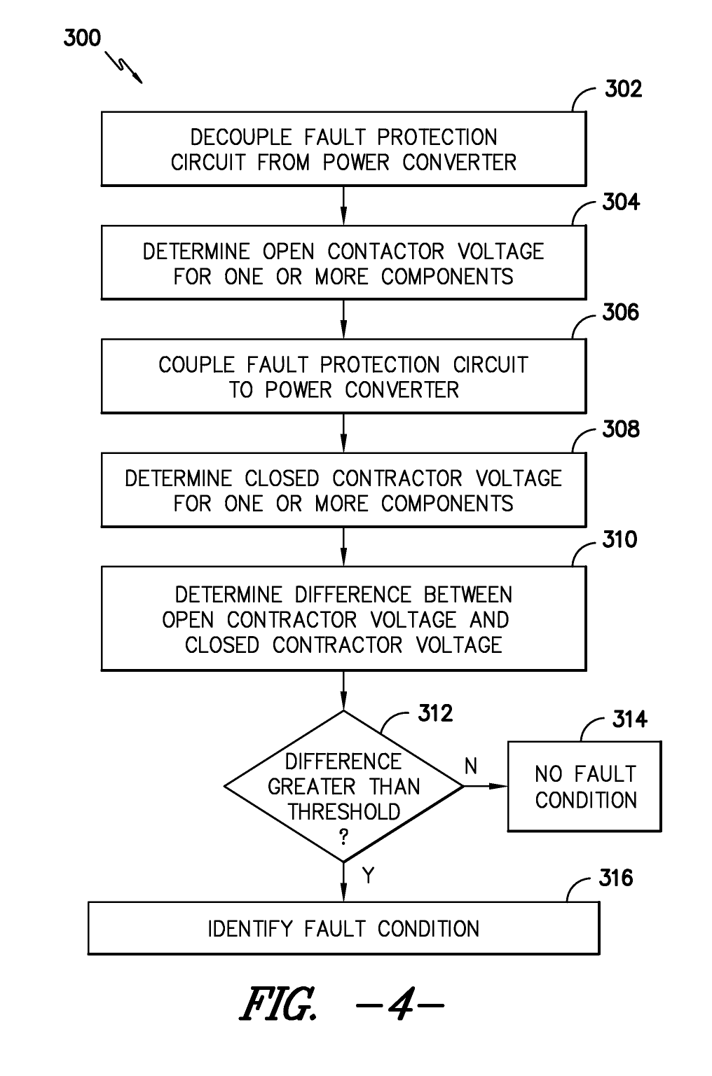

FIG. 4 depicts an exemplary fault protection method 300 according to an exemplary embodiment of the present disclosure. The method 300 will be discussed with reference to the power converter system 100 depicted in FIG. 3. Those of ordinary skill in the art, using the disclosures provided herein, will understand that the method 300 can be implemented by other power converter systems. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (302), the method temporarily decouples the fault protection circuit from the converter. For instance, the controller 130 opens contactor 146 to decouple the ground reference 150 from the power converter 120. At (304), the method determines the open contactor voltage for one or more components of the power converter system. The open contactor voltage is the voltage of a component when the power converter is decoupled from the fault protection circuit (i.e. the contactor is open). For instance, the controller 130 can determine the voltage of the PV array(s) input 102, the voltage of the positive bus 117 of the DC link 118, and/or the negative bus 119 of the DC link 118 using various voltage sensors when the contactor 146 is open.

At (306) the method couples the fault protection circuit back to the power converter. For instance, the controller 130 closes contactor 146 to couple the power converter 120 to the ground reference 150. At (308), the method determines the closed contactor voltage for one or more components of the power converter system. The closed contactor voltage is the voltage of a component when the power converter is coupled to the fault protection circuit (i.e. the contactor is closed). For instance, the controller 130 can determine the voltage of the PV array(s) input 102, the voltage of the positive bus 117 of the DC link 118, and/or the negative bus 119 of the DC link 118 using various voltage sensors when the contactor 146 is closed.

A difference between the open contactor voltage and the closed contactor voltage for a component can indicate the existence of a fault path in the power converter system. In this regard, the method determines at (310) the difference between the open contactor voltage and the closed contactor voltage for one or more components of the power converter system.

At (312), the method determines whether this difference is greater than a threshold. The threshold can be defined based on the particular component of the power converter system. The thresholds will be different depending on the component of the power converter system. If difference is not greater than the threshold, the method can determine that no fault condition exists (314). If so, the method can identify a fault condition (316) and provide the appropriate notification to a user and take other appropriate action, such as shutting down the power converter system.

The method 300 can be performed at any time, but is preferably performed during start up or shut down conditions for the power converter. In this manner, the coupling and decoupling of the power converter from the ground reference does not interfere with the normal operation of the power converter system. In addition, the exemplary method 300 has been discussed with reference to a grounded power converter that is normally coupled to a ground reference through a ground fault protection circuit. The method 300 is equally applicable to a floating power converter that is not normally coupled to a ground reference. In this case, the method temporarily couples the floating converter to ground to obtain closed contactor voltage measurements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power converter system, comprising:
a power converter couplable to one or more DC power sources, said power converter configured to convert DC power from the one or more DC power sources to AC power;
a fault protection circuit coupled between said power converter and a ground reference, said fault protection circuit comprising a fuse having a fuse current rating and a current sensor in series with said fuse, said current sensor configured to monitor the current flowing through said fault detection circuit; and,
a controller configured to receive a signal associated with the current flowing through said fault protection circuit from said current sensor, said controller configured to compare the current flowing through said fault protection circuit with a current threshold and to identify a fault condition when the current exceeds the current threshold value, the current threshold value being less than the fuse current rating of said fuse.

2. The power converter system of claim 1, wherein the current sensor comprises a current shunt.

3. The power converter system of claim 1, wherein the current sensor comprises a Hall effect current sensor.

4. The power converter system of claim 1, wherein the fault protection circuit further comprises a voltage sensor configured to monitor the voltage across said fuse.

5. The power converter system of claim 4, wherein the controller is configured to identify a minor fault condition when the current in the fault protection circuit exceeds the current threshold value and the voltage across said fuse does not exceed a voltage threshold value, the controller further configured to identify a major fault condition when the voltage across said fuse exceeds the voltage threshold value.

6. The power converter system of claim 1, wherein the controller is configured to provide a notification of the fault condition.

7. The power converter system of claim 1, wherein the fault protection circuit further comprises a contactor coupled in series with said fuse, said controller configured to open and close said contactor.

8. The power converter system of claim 7, wherein said controller is configured to determine a closed contactor voltage for one or more components of the power converter system when said contactor is closed; determine an open contactor voltage for one or more components of the power converter system when said contactor is open; and determine a fault condition based at least in part on a difference between the closed contactor voltage and the open contactor voltage for the one or more components of the power converter system.

9. The power converter system of claim 8, wherein the one or more components of the power converter system comprise one or more of an input from the photovoltaic source to the power converter, a positive DC bus for the power converter, or a negative DC bus for the power converter.

10. A ground fault protection method for a power converter system, the power converter system comprising a power converter couplable to one or more photovoltaic sources, the power converter configured to convert DC power from the one or more photovoltaic sources to AC power, the method comprising:
monitoring the current flowing through a fault protection circuit coupled between the power converter system and a ground reference, the fault protection circuit comprising a fuse having a fuse current rating;
monitoring the voltage across the fuse;
identifying a minor fault condition based at least in part on the current flowing through the fault protection circuit and the voltage across the fuse;
wherein the current flowing through the fault protection circuit as a result of the minor fault condition has a magnitude less than the fuse current rating of the fuse.

11. The ground fault protection method of claim 10, wherein identifying a minor fault condition comprises:
comparing the current flowing through the fault protection circuit to a current threshold value, the current threshold value being less than the fuse current rating; and,
comparing the voltage across the fuse to a voltage threshold value; and,
identifying a minor fault condition when the current exceeds the current threshold value and the voltage does not exceed the voltage threshold value.

12. The ground fault protection method of claim 11, wherein the method further comprises identifying a major fault condition when the voltage across the fuse exceeds the voltage threshold value.

13. The ground fault protection method of claim 10, wherein the method comprises:
selectively coupling and decoupling the power converter from the ground reference with a contactor coupled in series with the fuse;
determining an open contactor voltage of one or more components of the power converter system when the power converter is decoupled from the ground reference;
determining a closed contactor voltage of one or more components of the power converter system when the power converter is coupled to the ground reference;
determining the difference between the open contactor voltage and the closed contactor voltage; and,
identifying a fault condition based at least in part on the difference between the open contactor voltage and the closed contactor voltage.

14. The ground fault protection method of claim 10, wherein the method comprises providing a notification of the minor fault condition.

15. The ground fault protection method of claim 12, wherein the method comprises shutting down the power converter upon identification of a major fault condition.

16. A photovoltaic power converter system, comprising:
a power converter couplable to one or more photovoltaic sources, said power converter configured to convert DC power from the one or more photovoltaic sources to AC power;
a fault protection circuit coupled between said power converter and a ground reference, said fault protection circuit comprising a fuse having a fuse current rating and a contactor in series with said fuse; and,
a controller configured to open and close said contactor, said controller further configured to determine a closed contactor voltage for one or more components of the photovoltaic power converter system when said contactor is closed; determine an open contactor voltage for one or more components of the photovoltaic power converter system when said contactor is open; and, determine a fault condition based at least in part on a difference between the closed contactor voltage and the open contactor voltage for the one or more components of the photovoltaic power converter system.

17. The photovoltaic power converter system of claim 16, wherein the one or more components of the photovoltaic power converter system comprise one or more of an input from the photovoltaic source to the power converter, a positive DC bus for the power converter, or a negative DC bus for the power converter.

18. The photovoltaic power converter system of claim 16, wherein the fault protection circuit further comprises a current sensor in series with said fuse, said current sensor configured to monitor the current flowing through said fault protection circuit.

19. The photovoltaic power converter system of claim 18, wherein the controller is configured to receive a signal associated with the current flowing through said fault protection circuit from said current sensor, said controller configured to compare the current flowing through said fault protection circuit with a current threshold and to identify a fault condition when the current exceeds the current threshold value, the current threshold value being less than the fuse current rating of said fuse.

20. The photovoltaic power converter system of claim 19, wherein the fault protection circuit further comprises a voltage sensor configured to monitor the voltage across said fuse, the controller configured to identify a fault condition when the voltage across the fuse exceeds a voltage threshold value.
